(19) United States
(12) Patent Application Publication
(10) Pub. No.: US 2022/0333442 A1
(43) Pub. Date: Oct. 20, 2022

(54) PORTABLE LADDER

(71) Applicant: Edward A. Sirlin, III, Hollis, NH (US)

(72) Inventor: Edward A. Sirlin, III, Hollis, NH (US)

(21) Appl. No.: 17/235,031

(22) Filed: Apr. 20, 2021

(51) Int. Cl. E06C 1/38; E06C 1/10; E06C 1/34; E06C 1/387

(52) U.S. Cl. CPC E06C 1/381; E06C 1/10; E06C 1/34; E06C 1/387

(57) ABSTRACT

A portable ladder for securing to an object, such as a tree, is provided. The portable ladder includes first and second vertical supports, each with a channel extending therethrough. The vertical supports can be coupled together to form a ladder segment. The portable ladder also includes a plurality of steps coupled to the first and second vertical supports, and a primary strap extending through the channels in the first and second vertical supports. The first end of the primary strap extends out of the channel in the first vertical support and is configured to be wrapped around the object to form a strap loop, and the second end of the primary strap extends out of the channel in the second vertical support. The portable ladder further includes a locking device configured to lock the first end of the primary strap to the first vertical support, and a ratchet mechanism configured to be coupled to the second end of the primary strap to adjust the tension in the primary strap to tighten the strap loop around the object. Methods of securing the portable ladder to an object are also provided.

### FIELD OF THE INVENTION

The invention relates, in part, to a portable ladder and methods of securing the portable ladder to an object, such as a tree or a pole.

### BACKGROUND

A variety of products exist which are designed to be secured to a tree to enable a user to climb up the tree. These products are typically designed specifically for hunting purposes. For example, a climbing stand typically includes a seat and a standing platform with upper and lower rope portions secured around the back of the tree. A user can climb a tree by using the friction in the rope around the back of the tree, alternating upper and lower rope portions to ascend to a desired height. Second, a hanging stand may be used with tree steps that are separately attached to the tree. Third, a rigid ladder stand may be used which is typically leaning up against a tree at an angle and secured to the tree with several straps. Another option is a tripod stand with a seat at the top which may either be secured to a tree or may be used by itself (without a tree) when there are not suitable trees around. Finally, another product is a tree saddle which includes a lightweight platform and a harness/saddle attached to the tree, similar to a rock climbing harness, which a user can use to climb a tree.

### SUMMARY OF THE INVENTION

In a first aspect, a portable ladder for securing to an object is provided. The portable ladder includes at least a first vertical support and a second vertical support, where the first and second vertical supports can be coupled together to form a ladder segment. The first vertical support has a first channel extending therethrough, and the second vertical support has a second channel extending therethrough. The portable ladder also includes a plurality of steps coupled to the first and second vertical supports, and a primary strap extending through the first and second channels in the first and second vertical supports. The primary strap has a first end and a second end, where the first end of the primary strap extends out of the first channel in the first vertical support and is configured to be wrapped around the object to form a strap loop, and the second end of the primary strap extends out of the second channel in the second vertical support. The portable ladder also includes a locking device configured to lock the first end of the primary strap to the first vertical support, and a ratchet mechanism configured to be coupled to the second end of the primary strap to adjust the tension in the primary strap to tighten the strap loop around the object.

In another aspect, a method of securing a portable ladder to an object is provided. The method includes providing a ladder segment having a plurality of steps, the ladder segment including a first vertical support having a first channel extending therethrough, and a second vertical support having a second channel extending therethrough. The method also includes threading a primary strap through the first channel in the first vertical support and also threading the primary strap through the second channel in the second vertical support, the primary strap having a first end and a second end, where the first end of the primary strap extends out of the first channel in the first vertical support. The method also includes wrapping the first end of the primary strap around the object to form a strap loop, locking the first end of the primary strap to the first vertical support, elevating the first vertical support and strap loop up along the object, and coupling the second vertical support to the first vertical support end to end to form the ladder segment, where the second end of the primary strap extends out of the second channel in the second vertical support. The method also includes elevating the first and second vertical supports up the object to further raise the strap loop up on the object, and coupling the second end of the primary strap to a ratchet mechanism to adjust the tension in the primary strap to tighten the strap loop around the object.

### BRIEF DESCRIPTION OF THE DRAWINGS

FIG. 1 is a schematic view of one embodiment of a portable ladder secured to a tree;

FIG. 2 is a detailed view of one embodiment of a vertical support and a primary strap;

FIG. 3 is a detailed view of one embodiment of a locking device configured to lock the primary strap to the vertical support;

FIG. 4 is another detailed view of one embodiment of a locking device which includes a cotter pin and a locking clip;

FIG. 5 is another detailed view of one embodiment of a locking device in a locked state;

FIG. 6 is a detailed view of one embodiment of a vertical support which includes a pulley;

FIG. 7 is a schematic view of one embodiment of a first vertical support and a second vertical support with a primary strap extending through channels within the first and second vertical supports;

FIG. 8 is a schematic view of one embodiment of a portable ladder with a ratchet mechanism to adjust the tension in the primary strap; and

FIG. 9 is a detailed view of one embodiment of a vertical support which includes an angled conduit for the primary strap.

### DETAILED DESCRIPTION

The present disclosure is directed to a device designed to be secured to an object to enable a user to climb up the object. In particular, aspects of this disclosure are directed to a portable ladder for securing to an object, such as a tree or a pole. The inventor recognized numerous problems associated with the existing products discussed above. First, many of the existing products are cumbersome and heavy. Second, many of the existing products are time consuming to set up. Third, and perhaps most notably, some of the existing products are not safe and there is a significant risk of injury to the user.

Thus, as set forth in more detail below, aspects of the present disclosure are directed to a portable ladder which is lightweight and easy for a person to transport and carry to the location of use. Further aspects of the present disclosure are directed to a portable ladder which can be quickly and easily set up and installed on a tree, or other object. In one exemplary embodiment, the portable ladder can be assembled and secured to a tree in about 30-60 seconds, all while the user remains on the ground. This is in comparison to current top of the line products which can take about 15 minutes to assemble and secure to a tree. Furthermore, many of the current products require the user to climb up the unsecured device in order to secure the device to the tree. This is very undesirable as climbing an unsecured ladder poses a significant falling risk to the user. Thus, aspects of the present invention are directed to a portable ladder which is designed to greatly reduce the risk of falling to the user. According to one aspect of the present disclosure, the portable ladder is configured such that a user can fully secure it to the object (i.e. tree) while the user is still on the ground. In particular, the portable ladder may be configured so that a user can secure upper portions of the ladder to the tree, while the user is still on the ground. This is unlike many of the existing portable ladder products which require the user to ascend the ladder before the upper portion of the ladder is secured to the tree.

As mentioned above, many of the existing portable ladder products are specifically designed for hunting purposes. The present disclosure contemplates a portable ladder used for hunting. It is also contemplated that the below described portable ladders may, for example, be used by photographers, arborists, electricians and other types of workers and other outdoor enthusiasts, as the disclosure is not so limited.

Furthermore, the present disclosure is directed to a portable ladder that is configured to be secured to an object, such as a tree. It should also be recognized that the portable ladder may also be secured to other objects, such as, but not limited to various poles such as telephone poles and utility poles, and structural building supports, such as tall columns or decking supports.

As set forth in more detail below, aspects of the present invention are directed to a portable ladder which is configured to be secured to the tree prior to the user ascending the tree. This is a significant safety advantage over many of the existing portable ladders which require the user to ascend the ladder to secure the upper portion of the ladder to the tree. Details regarding this advantageous feature are described in more detail below.

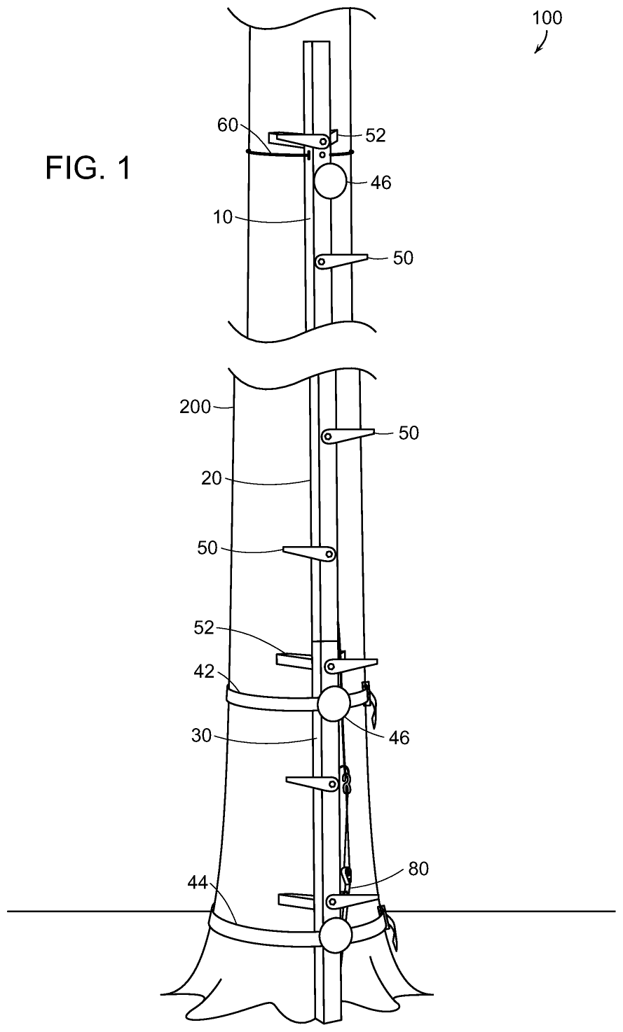

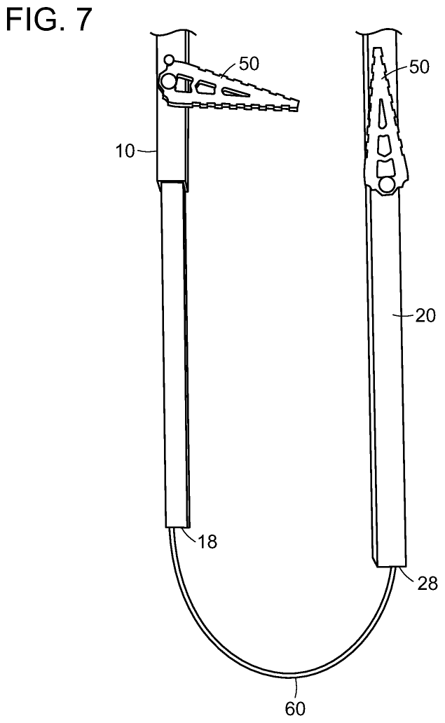

Turning now to FIG. 1, one embodiment of a portable ladder 100 will now be described. FIG. 1 illustrates the portable ladder 100 secured to a tree 200. The ladder 100 includes a plurality of vertical supports 10, 20, 30 stacked together to form a long vertical ladder segment. FIG. 1 illustrates a design with three vertical supports 10, 20, 30. Other embodiments may include designs with four, five, six or more vertical supports as the disclosure is not so limited. As shown in FIG. 1, the first vertical support 10 forms an upper support and the second and third vertical supports 20, 30 are lower supports that are subsequently coupled to the first vertical support 10. As set forth in more detail below, the vertical supports 10, 20 have a channel 18, 28 (see FIG. 7) extending therethrough. As shown in FIG. 1, there are a plurality of steps 50 coupled to the vertical supports 10, 20, 30 and a primary strap 60 extends around the tree to form a strap loop. As explained in more detail below, the primary strap 60 extends through the channels 18, 28 in the vertical supports 10, 20, and as shown in FIG. 1, a ratchet mechanism 80 is provided to adjust the tension in the primary strap 60 to tighten the strap loop around the tree 200. Details regarding the primary strap 60 and its ratchet mechanism 80 are discussed below.

As shown in FIG. 1, one or more secondary straps 42, 44 may also be provided to further secure the portable ladder 100 to the tree. In one embodiment, these secondary straps 42, 44 are configured to be secured around the tree 200 at a location where the user can reach the secondary straps 42, 44 without having to ascend the ladder 100. As shown, wheels 46, or other connections, may be used to secure a secondary strap 42, 44. Also, a plurality of brackets 52 may be coupled to the vertical supports 10, 20, 30 to space the vertical supports 10, 20, 30 and steps 50 away from the tree. These brackets 52 are configured to provide additional clearance for a user's foot on each step 50. The brackets 52 may also be shaped to provide additional points of contact between the portable ladder 100 and the tree 200 providing a more stable assembly. As discussed in more detail below, in one embodiment, the ladder 100 also includes a base section (not shown) that can be initially strapped, or otherwise secured, to a lower portion of the tree. The lower portion of the base section may have one or more legs to rest on the ground, and the upper portion of the base section may be configured to receive the lower most vertical support (which in the embodiment shown in FIG. 1 is the third vertical support 30) to provide additional stability to the portable ladder 100.

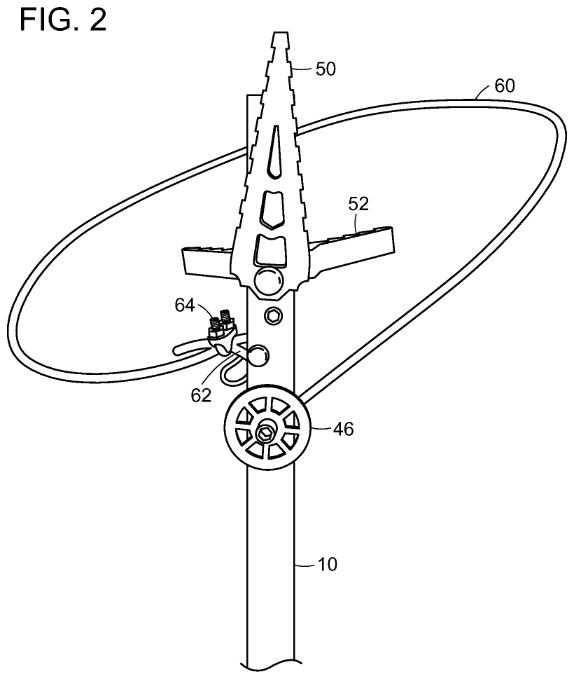

Also, in the embodiment illustrated in FIG. 1, the steps 50 are shown in an active position (i.e. in use position). In one embodiment, the steps 50 are movable between the active position and a more compact storage position. For example, as shown in FIG. 2, the steps 50 may be rotatable relative to the vertical supports 10, 20, 30 into a storage position. Other configurations that enable the steps 50 to a lower profile storage configuration are also contemplated, including, for example, slidable and retractable steps 50. In one embodiment, the steps 50 are spaced about 15-16 inches apart from each other.

It should be recognized by one of ordinary skill in the art that when this portable ladder 100 is secured to the tree 200 as shown in FIG. 1, it is straightforward for a user to ascend the ladder 100 by climbing up the steps 50. Although not shown in the drawings, it should also be appreciated that this portable ladder may be used in combination with any known seat, platform or saddle, which may be positioned at the top of the ladder. Furthermore, this portable ladder may also be used in combination with a safety line, which is typically tethered to a ladder on one end, and to the user on the other end (typically through a lineman's harness/belt), such that the user is securely attached to the ladder while climbing the ladder.

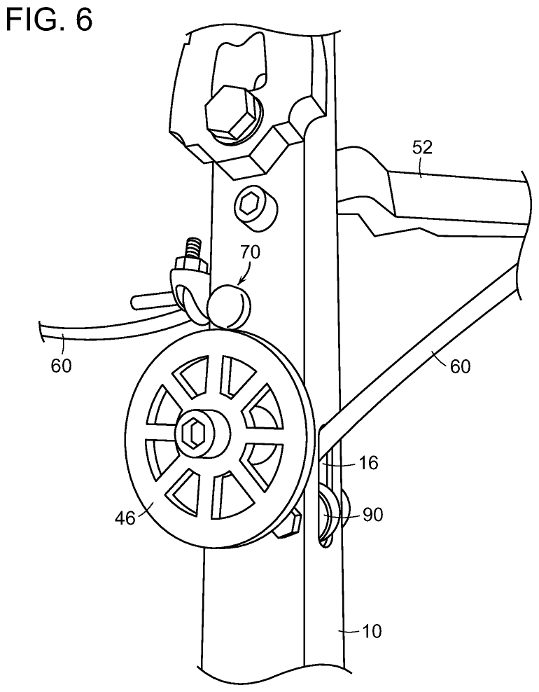

Turning now to FIGS. 2-6, additional details regarding the primary strap 60 and how it is secured to the vertical supports 10, 20, 30 will now be further described. FIG. 2 is a detailed view of one embodiment of a first vertical support 10 and the primary strap 60. As mentioned above, the primary strap 60 extends through a channel 18 (see FIG. 7) in the first vertical support 10. The channel 18 is discussed in more detail below, but in FIG. 2, the vertical support 10 is a hollow tube and the inside of the tube forms the channel 18. As shown in FIG. 2, a first end of the primary strap 60 extends out of the first vertical support 10 to wrap around the tree. Behind the wheel 46 is a hole/opening 16 (see FIG. 6) in the vertical support and a portion of the primary strap 60 is not visible in FIG. 2 because it extends through the hole/opening 16 in the vertical support 10 and into the lower portion of the first vertical support 10. In the orientation of FIG. 2, the hole 16 is not visible. FIG. 2 illustrates how the first end of the primary strap 60 extends out of the vertical support 10 to be wrapped around the object (i.e. tree 200) to form a strap loop). For simplicity, the tree 200 is not shown in FIG. 2.

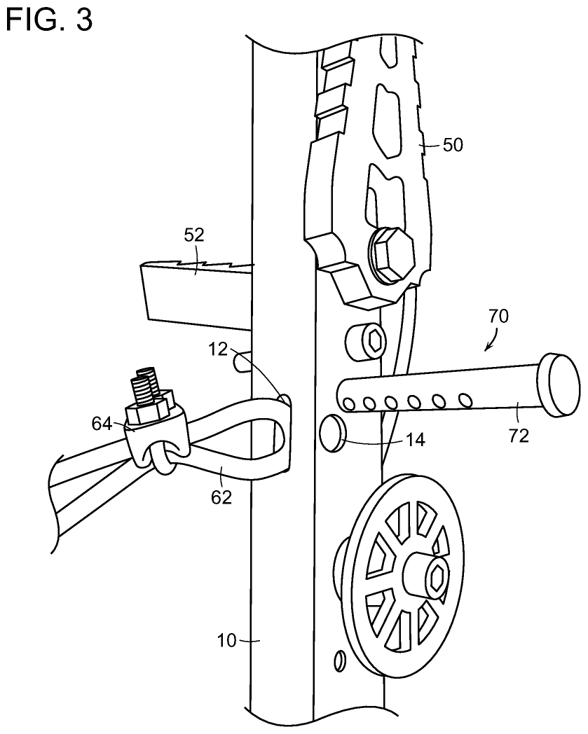

FIG. 3 is a detailed view of one embodiment of a portion of a locking device 70 configured to lock the primary strap 60 to the first vertical support 10. As set forth in more detail below, the locking device 70 may be configured to loosely lock the primary strap 60 to the first vertical support 10 (i.e. uppermost vertical support) so that the vertical support 10 and strap loop 60 may be easily raised up along the tree 200. Additional vertical supports 20, 30 may be attached to the first vertical support 10 and then raised up along the tree. As set forth in more detail below, once the portable ladder 100 is fully assembled on the tree and the upper strap 60 is raised to its final position, the ratchet mechanism 80 is used to tighten the primary strap 60 to the tree.

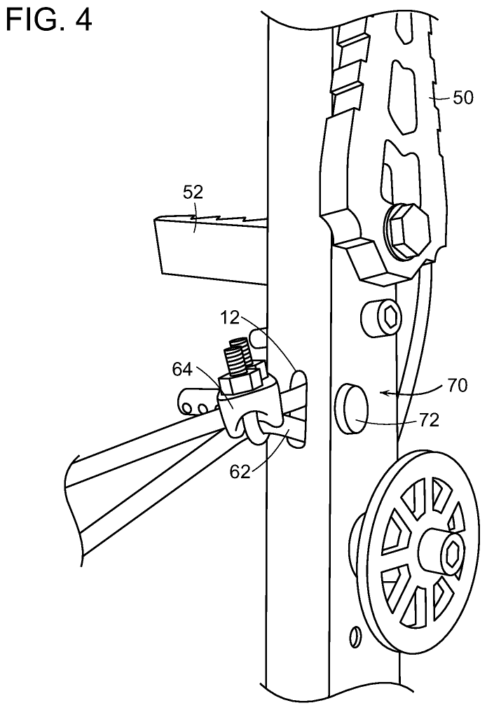

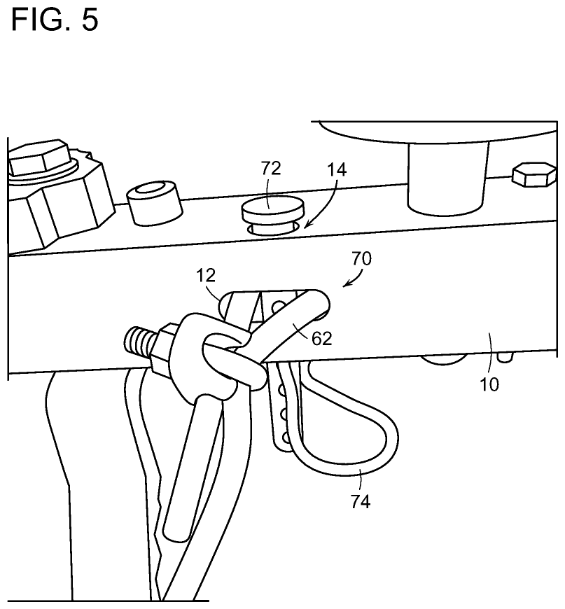

In the embodiment shown in FIG. 3, one end of the primary strap 60 includes a loop end 62, which is shown being inserted into a first hole 12 in the first vertical support 10. In this illustrative embodiment, the locking device 70 includes a pin 72 which is configured to be inserted into a second hole 14 in the first vertical support 10. As shown in FIGS. 3-4, the first and second holes 12, 14 in the vertical support 10 are aligned with each other such that when the pin 72 is inserted into the second hole 14 in the vertical support 10, the pin 72 also extends through the loop end 62 in the primary strap, thereby locking the primary strap 60. FIG. 4 is similar to FIG. 3, except it shows the pin 72 fully inserted into the second hole 14 in the vertical support 10. As shown in FIG. 5, in one embodiment, the locking device 70 also includes a locking clip 74 that is configured to be secured to the pin 72 to prevent the pin 72 from sliding out of the second hole 14. FIG. 5 illustrates the locking device 70 in a locked state.

FIGS. 2-5 illustrate one type of locking device 70 for locking the first end of the primary strap 60 to the first vertical support. Although this particular cotter pin/locking clip configuration is illustrated, it should be appreciated that other types of locking arrangements, such as, but not limited to carabiners, snap links, or hooks may also be used as the locking device 70 is not limited in this respect. Furthermore, FIGS. 2-5 illustrate the end of the primary strap 60 being formed into a loop end 62. In this particular illustrative embodiment, the loop end 62 is formed with a mechanical fastener 64 which is slid onto the end of end of the strap. It should be appreciated that in another embodiment, the primary strap 60 may be secured to the locking device 70 with other configurations as the present disclosure is not limited in this respect. Furthermore, FIGS. 3-5 depict the first hole/opening 12 in the vertical support 10 having an oval or oblong shaped slot to facilitate the insertion of the loop end 62 of the strap 60, and the second hole/opening 14 in the vertical support 10 having a circular shaped slot to facilitate insertion of the pin 72. It should be recognized that in another embodiment, the first and second holes/openings 12, 14, may have different shapes and configurations.

As outlined in more detail below, the present disclosure is directed to methods of securing the portable ladder 100 to an object, such as a tree 200. It should also be appreciated that once the locking device 70 loosely locks the first end of the primary strap 60 around the tree 200 and to the first vertical strap 10, the primary strap 60 and the first vertical support 10 can be elevated up the tree 10. The second vertical support 20 can be attached to the first vertical support 10 and the portable ladder can again be elevated up the tree 200 into the desired position. Likewise, the third vertical support 30 may also be attached to the second vertical support 20 and the entire assembly can be elevated up the tree, moving the upper end of the primary strap 60 to the desired position around the tree 200. This process can be repeated with, for example, a fourth, a fifth, and a sixth vertical support, until the top of the portable ladder is at the desired height on the tree 200.

Turning now to FIG. 6, which illustrates another detailed view of the first vertical support 10 and locking device 70 rotated approximately 90° degrees in comparison to FIGS. 2-5 to show another side of the vertical support 10. FIGS. 3-5 illustrate a first hole 12 (i.e. opening or slot) located on a first face of the vertical support 10, and a second hole 14 located on a second face of the vertical support 10, both first and second hole 14 configured so that the locking device 70 can lock the first end of the primary strap 60 to the first vertical support 10. As mentioned above, FIG. 6 shows the primary strap 60 extending through a third hole 16 (i.e. opening or slot) on a third face of the vertical support 10. In one embodiment, a pulley 90 is provided to enable the primary strap 60 to easily slide through the first channel 18 of the first vertical support 10. In particular, the pulley 90 may have a grooved rim configured to receive a portion of the primary strap 60 and it acts to change the direction of force applied to the primary strap 60. As set forth in more detail below, in another embodiment, the vertical support 10 may include other features to allow the primary strap 60 to slide more easily through the channel 18 and out of the hole 16 in the vertical supports 10.

In one embodiment, the second vertical support 20 also has a similar hole 16 (i.e. opening or slot) on one side surface so that the second end of the primary strap 60 extends out of the second channel 28 in the second vertical support 20. Similarly, a pulley 90 may also be provided to enable the primary strap 60 to slide through the second channel 28 of the second vertical support 20.

FIG. 7 illustrates one embodiment of a first vertical support 10 and a second vertical support 20 with a primary strap 60 extending through channels 18, 28 within the first and second vertical supports 10, 20. FIG. 7 illustrates the first and second vertical supports 10, 20 in a disassembled storage (and transport) configuration. As shown, this configuration enables the portable ladder 100 to be easily transported to the desired location. As mentioned above, the vertical supports 10, 20 can be coupled together to form a ladder segment. As shown, the primary strap 60 is threaded through the vertical supports 10, 20. It should be appreciated that in one embodiment, the portable ladder 100 has the primary strap 60 pre-threaded through the vertical supports 10, 20. In another embodiment, it is contemplated that the user can manually thread the primary strap 60 through the first and second vertical supports 10, 20.

In one embodiment, the first, second, and third (or more) vertical supports 10, 20, 30 are tubular members with interlocking connections at each end to couple the vertical supports 10, 20, 30 together. The vertical supports 10, 20 may have a rectangular cross-sectional shape (as in FIG. 7), circular cross-sectional shape, triangular cross-sectional shape, or any other shape, as the disclosure is not so limited. The vertical supports 10, 20, 30 may, for example, be hollow tubes made of various metals or plastics materials, and in one embodiment, they are made from aluminum tubes. It is contemplated that the interlocking connections on the vertical supports 10, 20, 30 may include male/female mechanical connections (as shown in FIG. 7), threads, or other conventional connections known to one of ordinary skill in the art. In one embodiment, each vertical support 10, 20, 30 is about 39 inches in length (with interlocking 3″ sections at each end). In one embodiment, the portable ladder 100 includes six vertical supports 10, 20, 30 which coupled together form an 18 foot portable ladder 100. In another embodiment, the portable ladder 100 includes four vertical supports 10, 20, 30 which coupled together form a 12 foot ladder. It should be appreciated that the portable ladder 100 can be made with any number of vertical segments 10, 20, 30 depending upon the overall desired ladder height. In one embodiment, the portable ladder 100 includes a bracket base section (not shown) which is attached to the base of the tree 200. The bracket base section may have a plurality of legs and it may serve as a base to receive the lower most vertical support 30. A strap may be used to secure the bracket base section to the tree 200.

In one embodiment, the primary strap 60 is made of a flexible but strong material that is capable of withstanding the tension and frictional forces to secure the portable ladder to an object, such as a tree 200. It is contemplated that the primary strap 60 is made of a cable, rope or other cord material. In one particular embodiment, the primary strap is made from 3/16″ outer diameter nylon-coated cable, rated to 2000 lb. break strength.

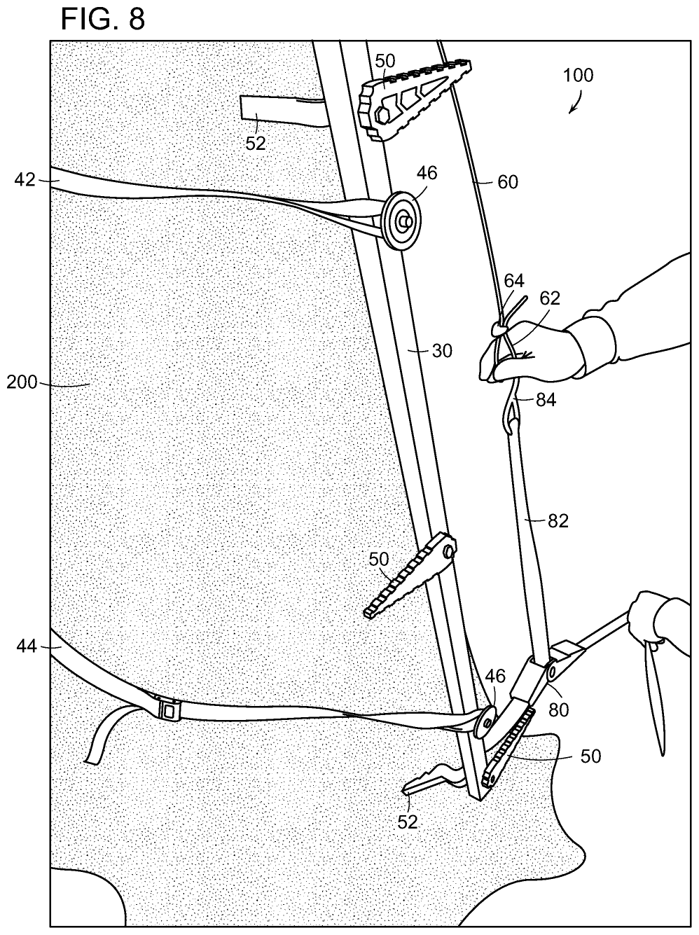

FIG. 8 illustrates one embodiment of a portable ladder 100 with a ratchet mechanism 80 to adjust the tension in the primary strap 60 to tighten the top strap loop around the object. In particular, FIG. 8 illustrates the lower portion of the portable ladder 100 coupled to a tree 200. As mentioned above, the ratchet mechanism 80 is configured to be coupled to the second end of the primary strap 60 to adjust the tension in the strap to tighten the strap loop around the tree. As shown in FIG. 8, in this particular embodiment, the second end of the strap 60 extends down along the third vertical support 30 and may end in a loop end 62 which is formed with a mechanical fastener 64 which is slid onto the end of end of the strap 60 (similar to the first end of the primary strap 60 described above). As shown in FIG. 8, the ratchet mechanism 80 may include a ratchet strap 82 which extends upwardly to a ratchet hook 84. As shown in FIG. 8, the user attaches the loop end 62 on the second end of the primary strap 60 to the ratchet hook 84. Then, the user can pull the ratchet strap 82, as shown in FIG. 8, to tighten the upper primary strap 60 around the tree 200. It should be appreciated that this streamlined design with a portion of the primary strap 60 extending within the first and second vertical supports 10, 20 enables the primary strap to slide within the channels 18, 28 as the primary strap 60 is being tightened. It is contemplated that this design prevents the strap 60 from getting caught on other components of the portable ladder 100 and/or portions of the tree 200.

It should be recognized that this above-described design enables a user to tighten the first end of the primary strap 60 which may be positioned high up on the tree 200 while the user is on the ground. In other words, with this design, as shown in FIG. 8, the user does not have to ascend the steps 50 to tighten the primary strap. As shown in FIG. 8, the secondary straps 42, 44 may be secured to the third vertical support 30 and the user may secure these secondary straps 42, 44 to the wheels 46 on the third vertical support 30 while the user is also positioned on the ground. In this respect, the portable ladder 100 may be fully secured to the tree 200 without requiring the user to ascend any of the stairs. Once these straps 42, 44, 60 are all secured to the tree, it should be recognized that a user may further add additional secondary straps (not shown) to further secure the portable ladder 100 to the tree 200. For example, the wheel 46 shown at the top on the first vertical support 10 may be used to secure another secondary strap. However, it should be recognized that this would be done after the primary strap 60 is tightened to the tree 200 with the ratchet system 80. It is also contemplated that in one embodiment, there may be a second ratchet system (not shown) configured to tighten the primary strap 60. The second ratchet system may be positioned at a midway point along the height of the portable ladder 100.

It is contemplated that this portable ladder 100 may be ideal for hunters with physical limitations and also for those of increased age. Dozens (if not hundreds) of hunters fall from conventional tree stands each year, primarily while applying steps to a tree or ascending the tree during the initial set up process. These falls can lead to severe injury, fractures, paralysis, and even death. Aspects of the present disclosure are directed to significantly reducing the most common dangerous aspect of ascending a tree, as it allows the user to be tethered or attached to the tree at all times and it avoids any unnecessary unsafe positions for the user.

As mentioned above, and as shown in FIG. 6, a pulley 90 may be provided to enable the primary strap 60 to slide through the first channel 18 of the first vertical support 10. As shown in FIG. 6, the pulley 90 may be positioned at least partially within the third hole 16 in the vertical support 10. In another embodiment, it is also contemplated that the third hole 16 includes a grommet and/or is coated with a material that eases movement of the primary strap through the vertical support 10.

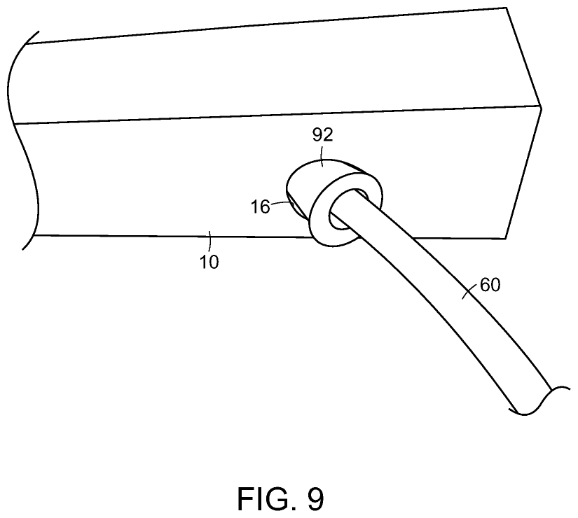

FIG. 9 illustrates another embodiment of a vertical support 10 which includes an angled conduit 92 for the primary strap 60. As shown in FIG. 9, the angled conduit 92 is positioned at the third hole/opening 16 in the vertical support 10 and it is configured to enable the primary strap 60 to slide more easily into and out of the vertical support 10 as the primary strap 60 slides through the vertical support 10 as the vertical supports are raised up the tree into position and also as the primary strap 60 is tensioned with the ratchet mechanism 80. In one embodiment, an angled conduit 92 is positioned on both the first vertical support 10 and also on the second vertical support 20. It may be desirable for the angled support on the first vertical support 10 to have an upwards orientation, and the angled support on the second vertical support 20 to have a downward orientation. In one embodiment, the angle of the angled conduit 92 relative to the vertical support 10, 20 is between approximately 30-60°, however, other angles are also contemplated.

The present disclosure also contemplates methods of securing the portable ladder 100 to an object, such as a tree 200. The method includes providing a ladder segment having a plurality of steps 50, the ladder segment including a first vertical support 10 having a first channel 18 extending therethrough, and a second vertical support 20 having a second channel 28 extending therethrough. As shown in FIG. 6, a primary strap 60 is threaded through the first channel 18 in the first vertical support 10 and also threaded through the second channel 28 in the second vertical support 20. The method also includes wrapping the first end of the primary strap 60 around the object to form a strap loop, and locking the first end of the primary strap 60 to the first vertical support 10. It should be appreciated that this may be done while the user in on the ground. Then, the method includes elevating the first vertical support 10 and strap loop up along the object. The method also includes coupling the second vertical support 20 to the first vertical support 10 end to end to form the ladder segment, where the second end of the primary strap 60 extends out of the second channel 18 in the second vertical support 20. The method also includes elevating the first and second vertical supports 10, 20 up the object to further raise the strap loop up on the object. The method also includes coupling the second end of the primary strap 60 to a ratchet mechanism 80 to adjust the tension in the primary strap 60 to tighten the strap loop around the object.

The above method of securing the portable ladder 100 to an object may also include rotating the plurality of steps 50 relative to the first and second vertical supports 10, 20, between a storage position and an active position.

It should be appreciated that in one embodiment, the primary strap 60 is pre-threaded through the first and second channels 18, 28 in the first and second vertical supports 10, 20, as shown in FIG. 7. In another embodiment the user may thread the primary strap through the vertical supports 10, 20. Also, in one embodiment, the first vertical support 10 and primary strap 60 are secured to the object and thereafter the second vertical support 20 is attached to the first vertical support 10. It is also contemplated that the act of coupling the second vertical support 20 to the first vertical support 10 end to end to form a ladder segment occurs before the first end of the primary strap 60 is wrapped around the object to form a strap loop.

As shown in FIGS. 3-5, in one embodiment, the act of locking the first end of the primary strap 60 to the first vertical support 10 further includes inserting a first end of the primary strap 60 into a first hole 12 on the first vertical support, inserting a cotter pin 72 into a second hole 14 on the first vertical support 10, and sliding a locking clip 74 into the cotter pin to prevent the cotter pin 72 from sliding out of the second hole 14. The method may also include wrapping a secondary strap 42, 44 around the object at a location spaced apart from where the primary strap 60 is wrapped around the object.

Furthermore, the method may include threading a primary strap 60 through the third channel in the third vertical support 30, coupling the third vertical support 30 to the second vertical support 20 end to end to form the ladder segment, where the second end of the primary strap 60 extends out of the third channel in the third vertical support 30, and elevating the first, second, and third vertical supports 10, 20, 30 up the object to further raise the strap loop up on the object. This process may be repeated to secure any additional vertical supports. For example, in one embodiment, there is a fourth, a fifth and a sixth vertical support.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

What is claimed is:

1. A portable ladder for securing to an object, the portable ladder comprising:
at least a first vertical support and a second vertical support, wherein the first and second vertical supports can be coupled together to form a ladder segment, wherein the first vertical support has a first channel extending therethrough, and the second vertical support has a second channel extending therethrough;
a plurality of steps coupled to the first and second vertical supports;
a primary strap extending through the first and second channels in the first and second vertical supports, the primary strap having a first end and a second end, wherein the first end of the primary strap extends out of the first channel in the first vertical support and is configured to be wrapped around the object to form a strap loop, and wherein the second end of the primary strap extends out of the second channel in the second vertical support;
a locking device configured to lock the first end of the primary strap to the first vertical support; and
a ratchet mechanism configured to be coupled to the second end of the primary strap to adjust the tension in the primary strap to tighten the strap loop around the object.

2. The portable ladder of claim 1, wherein the primary strap is made of a cable, rope or cord material.

3. The portable ladder of claim 1, wherein the first and second vertical supports are tubular members with interlocking connections at each end to couple the first vertical support to the second vertical support.

4. The portable ladder of claim 1, wherein the plurality of steps are rotatable relative to the first and second vertical supports, between a storage position and an active position.

5. The portable ladder of claim 1, wherein the first vertical support further comprises at least one pulley configured to enable the primary strap to slide through the first channel of the vertical support.

6. The portable ladder of claim 1, wherein the first vertical support further comprises an angled conduit for the primary strap.

7. The portable ladder of claim 1, wherein the locking device comprises a cotter pin and a locking clip, and wherein the first vertical support has a first hole and a second hole, wherein the first hole is configured to receive the first end of the primary strap, and the second hole is configured to receive the cotter pin to lock the first end of the strap to the first vertical support.

8. The portable ladder of claim 1, further comprising a plurality of brackets coupled to the first and second vertical supports, wherein the brackets are configured to space the vertical supports and steps away from the object.

9. The portable ladder of claim 1, further comprising one or more secondary straps configured to be wrapped around the object at a location spaced apart from where the primary strap is wrapped around the object.

10. The portable ladder of claim 1, further comprising a third vertical support with a third channel therethrough, wherein the third vertical support can be coupled to the first and second vertical supports to form the ladder segment.

11. A method of securing a portable ladder to an object, the method comprising:
providing a ladder segment having a plurality of steps, the ladder segment including a first vertical support having a first channel extending therethrough, and a second vertical support having a second channel extending therethrough;
threading a primary strap through the first channel in the first vertical support and also threading the primary strap through the second channel in the second vertical support, the primary strap having a first end and a second end, wherein the first end of the primary strap extends out of the first channel in the first vertical support;
wrapping the first end of the primary strap around the object to form a strap loop;
locking the first end of the primary strap to the first vertical support;
elevating the first vertical support and strap loop up along the object;
coupling the second vertical support to the first vertical support end to end to form the ladder segment, wherein the second end of the primary strap extends out of the second channel in the second vertical support;
elevating the first and second vertical supports up the object to further raise the strap loop up on the object; and
coupling the second end of the primary strap to a ratchet mechanism to adjust the tension in the primary strap to tighten the strap loop around the object.

12. The method of claim 11, further comprising:
rotating the plurality of steps relative to the first and second vertical supports, between a storage position and an active position.

13. The method of claim 11, wherein the act of locking the first end of the primary strap to the first vertical support further comprises:
inserting a first end of the primary strap into a first hole on the first vertical support;
inserting a cotter pin into a second hole on the first vertical support; and
sliding a locking clip into the cotter pin to prevent the cotter pin from sliding out of the second hole.

14. The method of claim 11, further comprising:
wrapping a secondary strap around the object at a location spaced apart from where the primary strap is wrapped around the object.

15. The method of claim 11, wherein the primary strap is pre-threaded through the first and second channels in the first and second vertical supports.

16. The method of claim 11, wherein the act of coupling the second vertical support to the first vertical support end to end to form a ladder segment occurs before the first end of the primary strap is wrapped around the object to form a strap loop.

17. The method of claim 11, wherein the ladder segment further includes a third vertical support having a third channel extending therethrough, and the method further comprises:
threading a primary strap through the third channel in the third vertical support;
coupling the third vertical support to the second vertical support end to end to form the ladder segment, wherein the second end of the primary strap extends out of the third channel in the third vertical support; and
elevating the first, second, and third vertical supports up the object to further raise the strap loop up on the object.
